(19) United States
(12) Patent Application Publication
(10) Pub. No.: US 2011/0167792 A1
(43) Pub. Date: Jul. 14, 2011

(54) ADAPTIVE ENGINE

(76) Inventors: JAMES EDWARD JOHNSON, Cincinnati, OH (US); Brandon Flowers Powell, Cincinnati, OH (US)

(21) Appl. No.: 12/642,967

(22) Filed: Dec. 21, 2009

Related U.S. Application Data
(60) Provisional application No. 61/246,075, filed on Sep. 25, 2009.
(60) Provisional application No. 61/263,107, filed on Nov. 20, 2009.

(51) Int. Cl. F02K 3/02

(52) U.S. Cl. 60/226.3

(57) ABSTRACT

An adaptive gas turbine engine is disclosed having a convertible fan system adapted to have a variable fan pressure ratio while the air flow into the convertible fan system remains substantially constant and an adaptive core having a compressor capable of maintaining a substantially constant core pressure ratio while a core airflow flow rate is varied.

### CROSS-REFERENCE TO RELATED APPLICATIONS

This application claims priority to U.S. Provisional Application Ser. No. 61/246,075, filed Sep. 25, 2009, and to U.S. Provisional Application Ser. No. 61/263,107, filed Nov. 20, 2009, which are herein incorporated by reference in their entirety.

### BACKGROUND OF THE INVENTION

This invention relates generally to jet propulsion engines, and more specifically to versatile engines having convertible fan systems capable of operating under variable flow conditions and pressure ratios.

Many current and most future aircraft need efficient installed propulsion system performance capabilities at diverse flight conditions and over widely varying power settings for a variety of missions. Current turbofan engines are limited in their capabilities to supply this type of mission adaptive performance, in great part due to the fundamental operating characteristics of their existing fan systems which have limited flexibility in efficiently reducing fan pressure ratio while maintaining high levels of fan flow. In the art, current turbofan engines use fan rotor speed reduction, sometimes coupled with a variable throat exhaust nozzle system, to reduce both fan pressure ratio and airflow as the engine is throttled back during part-power operation. This lack of operational flexibility limits the possibility of fully optimizing part power uninstalled specific fuel consumption levels. Further, the limitations in the current fan systems severely restrict making major improvements in spillage and nozzle closure drag losses that cause large increases in part-power installed specific fuel consumption levels.

Future mixed mission morphing aircraft as well as more conventional mixed mission capable military systems that have a high value of take-off thrust/take-off gross weight, i.e., a thrust loading in the 0.8-1.2 category, present many challenges to the propulsion system. They need efficient propulsion operation at diverse flight speeds, altitudes, and particularly at low power settings where conventional engines operate at inefficient off-design conditions both in terms of uninstalled performance and, to an even greater degree, fully installed performance that includes the impact of spillage drag losses associated with both subsonic and supersonic inlets.

When defining a conventional engine cycle and configuration for a mixed mission application, compromises have to be made in the selection of fan pressure ratio, bypass ratio, and overall pressure ratio to allow a reasonably sized engine to operate effectively at both subsonic and supersonic flight conditions. In particular, the fan pressure ratio and related bypass ratio selection needed to obtain a reasonably sized engine capable of developing the thrusts needed for combat maneuvers and supersonic operation are non-optimum for efficient low power subsonic flight. Basic uninstalled subsonic engine performance is compromised and fully installed performance suffers even more due to the inlet/engine flow mismatch that occurs at reduced power settings.

In the art, the core concepts used in convertible engines are quite complex, having multiple cores with complex ducting and valving needs. Current conventionally bladed core in engines cannot maintain constant or near constant operating pressure ratios as core flow is reduced. Current conventionally bladed fan rotors do not have the flexibility in efficiently reducing fan pressure ratio while maintaining high levels of fan flow. This lack of operational flexibility limits the possibility of fully optimizing part power uninstalled specific fuel consumption levels. This severely limits the potential Specific Fuel Consumption (SFC) advantage offered by known variable bypass convertible engine concepts.

Accordingly, it would be desirable to have an engine having a convertible fan system that allows thrust effective overall fan pressure ratio to be efficiently reduced while maintaining constant or near-constant total inlet flow during part-power engine operation, such as, for example, when the thrust is lowered to match aircraft drag during cruise operation. It would be desirable to have methods of operating convertible fans under conditions of variable flow and pressure ratio settings while providing the SFC advantages over various flight regimes. It would be desirable to have convertible fan engines having adaptive cores that combine the advantages of convertible fan engines and lower SFC at various power settings.

### BRIEF DESCRIPTION OF THE INVENTION

The above-mentioned need or needs may be met by exemplary embodiments disclosed herein which provide an adaptive gas turbine engine having a convertible fan system adapted to have a variable fan pressure ratio while the air flow into the convertible fan system remains substantially constant and an adaptive core having a compressor capable of maintaining a substantially constant core pressure ratio while a core airflow flow rate is varied.

In one aspect of the invention, adaptive gas turbine engine has an adaptive core having a front-block compressor and a rear-block compressor. In another aspect of the invention, the adaptive core has a rear-block bypass passage adapted to receive a flow from an annular inter-block passage. In another aspect of the invention, the convertible fan system has an outer bypass passage and an inner bypass passage. In another aspect of the invention, the convertible fan system has a bypass door that is adapted to control a core bypass flow. In another aspect of the invention, the convertible fan system has a blocker door that is adapted to prevent a reverse flow in the outer bypass passage.

### BRIEF DESCRIPTION OF THE DRAWINGS

The subject matter which is regarded as the invention is particularly pointed out and distinctly claimed in the concluding part of the specification. The invention, however, may be best understood by reference to the following description taken in conjunction with the accompanying drawing figures in which:

FIG. 1 is a schematic cross-sectional view of a versatile gas turbine engine according to an exemplary embodiment of the present invention.

FIG. 2 is a schematic cross-sectional view of a convertible fan system according to an exemplary embodiment of the present invention.

FIG. 3 is a schematic cross-sectional view of a convertible fan system according to another exemplary embodiment of the present invention.

FIG. 4 is a schematic cross-sectional view of a convertible fan system according to another exemplary embodiment of the present invention.

FIG. 5 is a schematic cross-sectional view of a versatile gas turbine engine according to another exemplary embodiment of the present invention.

FIG. 6 is an example of the fan operating characteristics of the front block of the convertible fan system shown in FIGS. 2, 5 and 9.

FIG. 7 is an example of the fan operating characteristics of outer portion of the aft fan of the convertible fan system shown in FIGS. 2, 5 and 9.

FIG. 8 is an example of the fan operating characteristics of inner portion of the aft fan of the convertible fan system shown in FIGS. 2, 5 and 9.

FIG. 9 is a schematic cross-sectional view of an exemplary versatile gas turbine engine having an adaptive core according to another exemplary embodiment of the present invention.

FIG. 10 is an example of the operating characteristics of the compressor of the exemplary versatile gas turbine engine shown in FIG. 9.

### DETAILED DESCRIPTION OF THE INVENTION

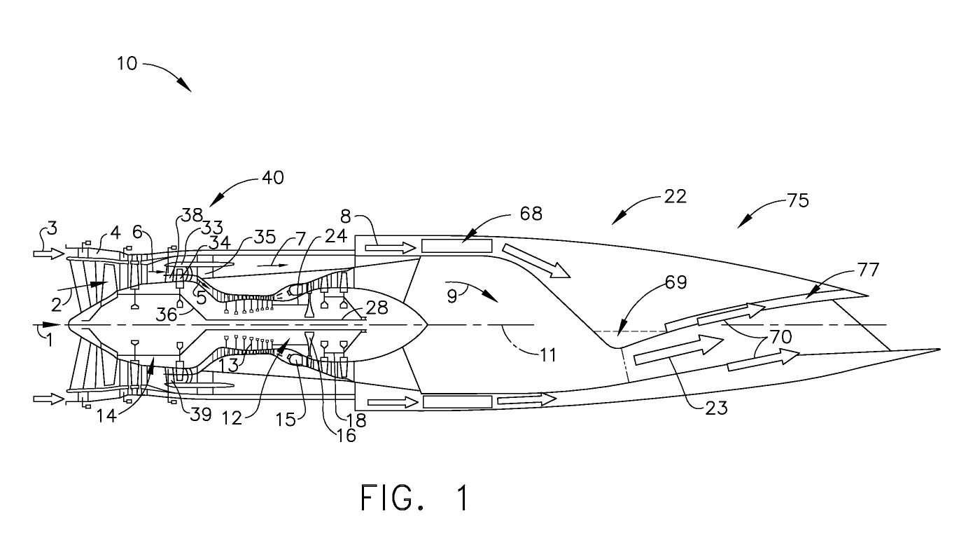

Referring to the drawings wherein identical reference numerals denote the same elements throughout the various views, FIG. 1 is a schematic cross-sectional view of an adaptive, versatile gas turbine engine 10 according to an exemplary embodiment of the present invention. The gas turbine engine 10 has a fan 14, a core 12 comprising a compressor 13 driven by a high-pressure turbine (HPT) 16 shaft 24. The fan 14 comprises a convertible fan system 40 having a longitudinal axis 11 and is driven by a low-pressure turbine (LPT) 18 shaft 28. The HPT 16 and LPT 18 are driven by the hot combustion gases from a combustor 15. In some applications, the engine 10 may optionally have an outer flow passage 4 that receives an outer flow stream 3 and an outer fan system as described subsequently herein. The inlet air flow stream 1 enters the front of the engine 10. The fan flow stream 2 is pressurized by the fan 14 and splits into one or more bypass flow streams 6 and a core flow stream 5. The one or more bypass flow streams 6 bypass the core 12 of the engine and enter the exhaust system 22. The core flow stream 5 enters the core 12 of the engine and is further compressed by the compressor 13 before entering the combustor 15. The core bypass flows and the exhaust from the LPT are mixed to form the inner exhaust stream 9 which is further expanded in the variable throat area exhaust system 22 forming the main engine exhaust flow stream 23.

As shown in FIGS. 1-5 and 9 and described herein in various exemplary embodiments, the engine 10 comprises a convertible fan system, such as, for example, item 40 in FIG. 1, that is coaxial with the engine centerline axis 11 and located inside a convertible fan casing 33 that is supported by known frame structures, such as struts 35. The convertible fan system 40 shown in FIG. 1 comprises a plurality of convertible fan blades 34 and one or more sets of variable vanes 38, 39 to control the air flow and pressure ratio as described subsequently. In the exemplary embodiment shown in FIG. 1, the convertible fan rotor is driven by a convertible fan shaft 36 that is coupled to the LPT shaft 28.

When an outer flow passage 4 is present, the outer flow stream 4 may be further pressurized by an outer fan system and form an outer exhaust stream 8. The outer fan is alternatively referred to herein by the term “FLADE™” which is an acronym for “Fan tip on BLADE”. The term FLADE™, as used herein, is characterized by an outer fan coupled to a radially inner fan. The FLADE™ discharges the FLADE™ air stream 8 into an outer fan duct which is generally co-annular with and circumscribes an inner fan duct. In some exemplary embodiments of the invention disclosed herein, a heat exchanger system 68 (see FIG. 1 for example) is provided wherein the heat exchanger system is capable of cooling the engine cooling air using the air stream 8. In some embodiments, the heat exchanger system 68 may also be used to collect and recover aircraft system waste heat energy. Further, in the exemplary embodiments of the invention disclosed herein, a variable throat area 69 (see FIG. 1, for example) is provided in the engine exhaust system 22 wherein the main exhaust nozzle throat area can be varied as necessary, such as for example, by opening the throat area when the engine thrust is reduced.

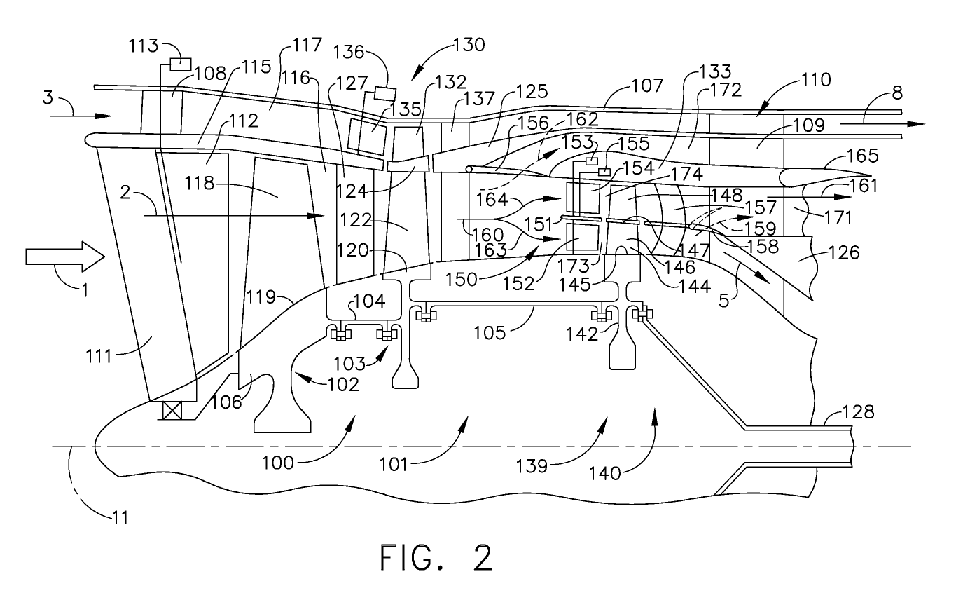

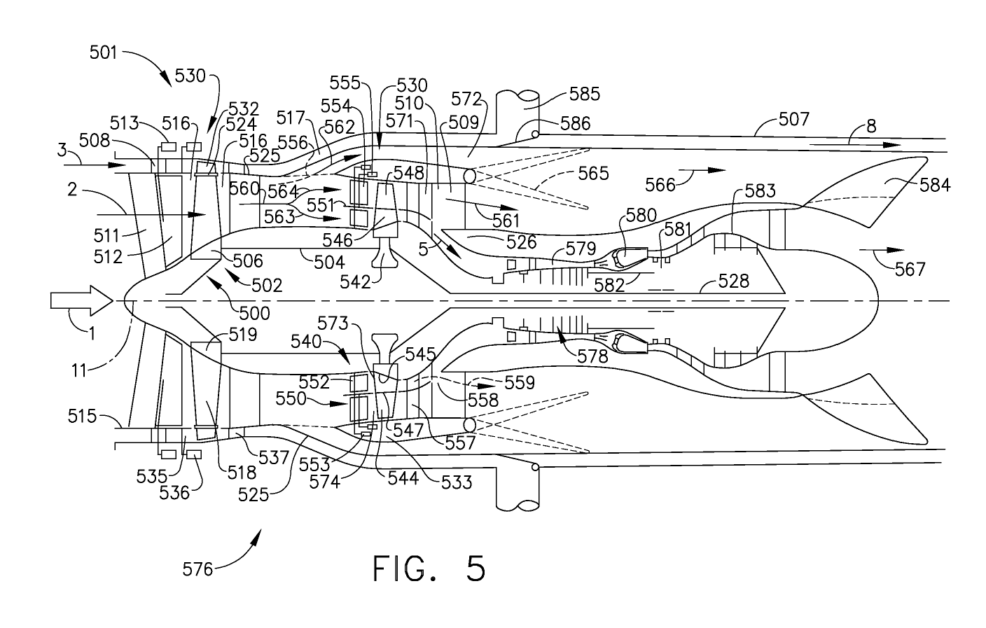

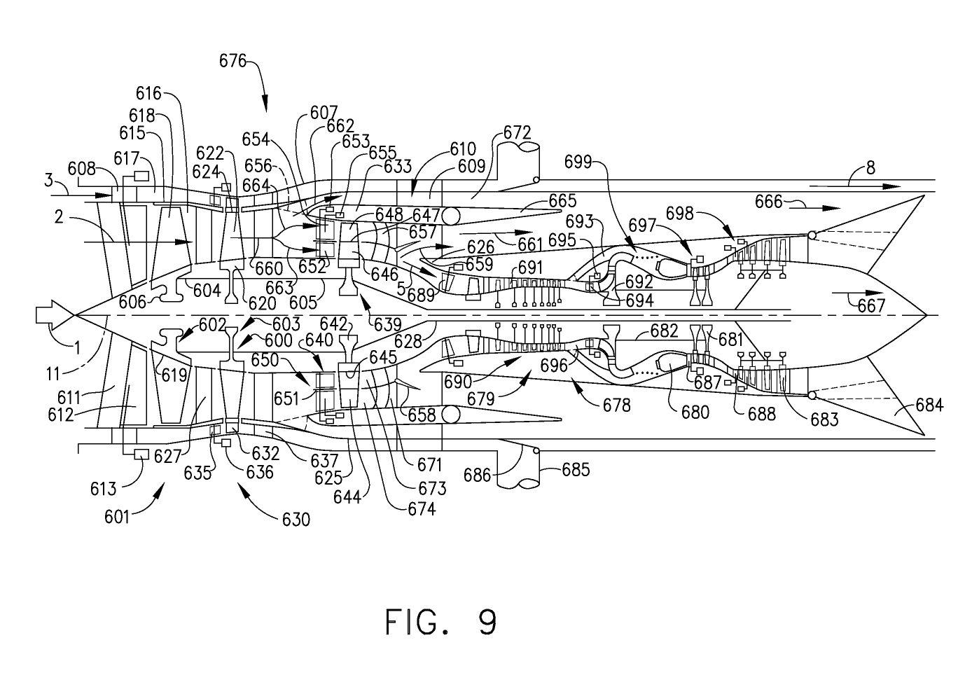

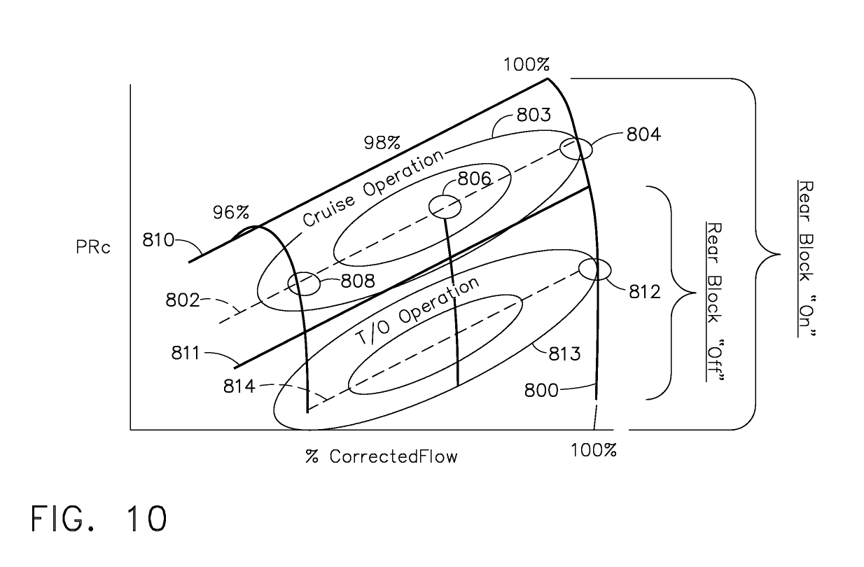

FIG. 2 is a schematic cross-sectional view of a convertible fan system (“CF”) 140 according to a preferred embodiment of the present invention. FIGS. 5 and 9 show exemplary embodiments of gas turbine engines 576, 676 having convertible fan systems, such as, for example, shown in FIG. 2. As shown in FIGS. 2, 5 and 9 the convertible fan system 140, 540, 640 comprises a convertible (CF) fan rotor 142, 542, 642 (alternatively referred to herein as “aft fan rotor”) having a plurality of CF fan blades 144, 544, 644 (alternatively referred to herein as “aft fan blade”) radially extending from a hub 145, 545, 645 and arranged circumferentially around a longitudinal axis 11. Each CF fan blade 144, 544, 644 has an arcuate shroud 147, 547, 647 (alternatively referred to herein as “arcuate splitter”) located radially outward from the hub. In the assembled state of the CF fan rotor 142, 542, 642 the arcuate shroud of a CF Fan blade 144, 544, 644 abuts the arcuate shrouds of the circumferentially adjacent CF fan blades 144, 544, 644 to form an annular splitter in the CF fan rotor 142, 542, 642. In alternative embodiments of the present invention, the CF fan rotor 142, 542, 642 may be manufactured as a single part (alternatively known as a “BLISK”) using known BLISK manufacturing methods. In other alternative embodiments, one or more of the forward fan stages may be manufactured as a BLISK. Although the fan blades and rotors shown herein are sometimes described as assemblies of parts, a fan system using BLISKS with the features described herein are within the scope of the present invention. The CF fan rotor 142, 542, 642 is located radially within a CF fan casing 133, 533, 633 that circumferentially surrounds the CF fan rotor 142, 542, 642 with a small clearance between the casing 133, 533, 633 and the CF fan blade tips. In the assembled state, the arcuate shrouds 147, 547, 647 form a portion of an inner flow passage 173, 573, 673 between the annular splitter and the hub of the CF fan rotor 142, 542, 642, and an outer flow passage 174, 574, 674 between the annular splitter and the casing 133, 533, 633. During operation of the CF fan system 140, 540, 640, the inner portion 146, 546, 646 of the CF fan blade 144, 544, 644 pressurizes an inner flow 163, 563, 663 in the inner flow passage 173, 573, 673 and the outer portion 148, 548, 648 of the fan blade 144, 544, 644 pressurizes an outer flow 164, 564, 664 in the outer flow passage 174, 574, 674.

The exemplary convertible fan systems 140, 540, 640 shown in FIGS. 2, 5 and 9 comprise a vane system 150, 550, 650 located axially forward from the convertible fan rotor 142, 542, 642. The exemplary vane system 150, 550, 650 shown in FIGS. 2, 5 and 9 has a plurality of outer vanes 154, 554, 654 that are arranged circumferentially around the longitudinal axis 11 and are located axially forward from the outer portions 148, 548, 648 of the fan blades 144, 544, 644. The outer vanes 154, 554, 654 are suitably supported by a static structure, such as for example, the CF fan casing 133, 533, 633 using known methods. The exemplary convertible fan system 140, 540, 640 shown in FIGS. 2, 5 and 9 comprises a static annular flow splitter 151, 551, 651 that splits the incoming CF flow stream 160, 560, 660 into a radially outer flow 164, 564, 664 and a radially inner flow 163, 563, 663. The static annular flow splitter 151, 551, 651 is located axially forward from the CF fan rotor 142, 542, 642. The static CF flow splitter 151, 551, 651 is located radially corresponding to the radial location of the arcuate splitters 144, 544, 644 on the CF blades 144, 544, 644 such that the outer vanes 154, 554, 654 direct the CF fan outer flow 164, 564, 664 into the CF fan blade outer portion 148, 548, 648. The outer vanes 154, 554, 654 are variable vanes such that they can vary the volume and direction of the flow entering the CF fan blade 144, 544, 644 and the outer flow passage 174, 574, 674 such that fan tip pressure ratio of the fan system 140, 540, 640 can be varied. The variable outer vanes 154, 554, 654 are actuated by known methods to vary the stagger angle of the outer vanes between about zero degree (open) and about 90 degrees (closed) using known outer vane actuators 155, 555, 655.

The exemplary vane system 150, 550, 650 shown in FIGS. 2, 5 and 9 also comprises a plurality of radially inner vanes 152, 552, 652 that are arranged circumferentially around the longitudinal axis 11 and are located axially forward from the inner portions 146, 546, 646 of the fan blades 144, 544, 644. The inner vanes 152, 662, 652 are suitably supported by a static structure, such as for example, the annular splitter 151, 551, 651 and the CF fan casing 133, 533, 633 using known methods. The inner vanes 152, 552, 652 direct the CF fan inner flow 163, 563, 663 into the CF fan blade inner portion 146, 546, 646. The inner vanes 152, 552, 652 are variable vanes such that they can vary the volume and direction of the flow entering the CF fan blade 144, 544, 644 and the inner flow passage 173, 573, 673 such that fan hub pressure ratio of the fan system 140, 540, 640 can be varied. The variable inner vanes 152, 552, 652 are actuated by known methods to vary the stagger angle of the inner vanes between about zero degree (open) and about 40 to 50 degrees (partially closed) using known inner vane actuators 153, 553, 653. In some applications, the inner vanes 152, 552, 652 are optionally used during starting and low power operation to maintain an adequate level of CF fan hub stall margin for the inner portions 146, 546, 646 of the CF fan blades 144, 544, 644.

During operation of the CF fan system 140, 540, 640 the outer flow stream 164, 564, 664 that is pressurized by the outer portion 148, 548, 648 of the CF fan blade 144, 544, 644 is directed by a circumferential array of CF fan outlet guide vanes (OGV) 157, 557, 657 to enter an inner bypass passage 171, 571, 671. The inner flow stream 163, 563, 663 that is pressurized by the inner portion 146, 546, 646 of the CF fan blade 144, 544, 644 is directed by a circumferential array of CF fan outlet guide vanes to enter an inner passage and forms a core flow stream 5 that enters the engine core. In one aspect of the present invention, the convertible fan system 140, 540, 640 optionally comprises a hub bleed system having a bypass bleed door 158, 558, 658 that can be selectively be opened using known methods such that a portion of the core flow 5, shown as core bypass flow 159, 559, 659 in FIGS. 2, 5 and 9 can be blown into the inner bypass passage 171, 571, 671. In some applications, the hub bleed system using the bypass door 158, 558, 658 is optionally used during starting and low power operation to maintain an adequate level of CF fan hub stall margin for the inner portions 146, 546, 646 of the CF fan blades 144, 544, 644.

The exemplary convertible fan system 140 further comprises an outer bypass passage 172. 572, 672 formed between an annular aft inner casing 125, 525, 625 and an annular outer casing 107, 507, 607. An annular outer bypass flow 162, 562, 662 flows through the outer bypass passage 172, 572, 672. The outer bypass flow 162, 562, 662 and the inner bypass flow 161, 561, 661 in the inner bypass passage 171, 571, 671 mix down-stream from the convertible fan system 140, 540, 640. An optional variable mixer 165, 565, 665 suitably shaped using known aerodynamic design methods is used at the aft end of the inner casing 133, 533, 633 to enhance the mixing of the outer bypass flow 162, 562, 662 and the inner bypass flow 161, 561, 661 and achieve a suitable static pressure balance, and to maintain adequate level of CF fan stall margin for the outer portions 148, 548, 648 of the CF fan blades 144, 544, 644. The exemplary convertible fan system 140, 540, 640 comprises a blocker door 156, 556, 656 located near the inlet portion of the outer bypass passage 172, 572, 672 such that it is controllably opened or closed using known actuation methods to control the amount of outer bypass flow 162, 562, 662. The blocker door 156, 556, 656 is modulated to close as necessary to prevent a reversal of flow in the outer bypass passage 172, 572, 672 that may be caused by a higher pressure down-stream from the CF fan rotor 142, 542, 642. The blocker door 156, 556, 656 is suitably supported by a static structure such as the aft inner casing 125, 525, 625 or frames.

FIG. 2 shows a multi-stage fan system 101 having a forward fan system 100 and an aft fan system 139. The aft fan system 139 shown is a convertible fan system 140, described previously herein. The forward fan system 101 comprises a first fan stage 102 and a second fan stage 103. In alternate embodiments of the present invention, the forward fan system 100 may comprise only one stage, such as, for example, shown in FIG. 5. As shown in FIG. 2, the first fan stage 102 comprises a first stage fan rotor 106 having a plurality of first stage fan blades 118 radially extending from a hub 119 and arranged circumferentially around the longitudinal axis 11. A circumferential array of fan inlet guide vanes 111 (Fan IGV) is located axially forward from the first fan stage 102. The fan IGVs 111 may have a variable vane 112 portion that is actuated by an actuator 113 of a known type. The first stage fan blades 118 are located inside an annular forward inner casing 115 that forms a portion of the fan inner flow path 116. The inner casing 115 is suitably supported by a static structure, such as, for example, struts 108. In one embodiment, shown in FIG. 2, a circumferential array of vanes 127 is located axially aft from the first stage fan rotor 106 to reorient the fan flow stream 2 after it is pressurized by the first stage fan blades 118.

A second fan stage 103 is located axially aft from the first fan stage 102 and coupled by a suitable means, such as a drive shaft 104. As shown in FIG. 2, the second fan stage 103 comprises a second stage fan rotor 120 having a plurality of second stage fan blades 122 arranged circumferentially around the longitudinal axis 11. In the exemplary embodiment shown in FIG. 2, the second stage fan blades 122 are coupled to an arcuate platform 124 located at the tip of the blades 122. The arcuate platform 124 may be suitably formed by assembling a circumferential array of abutting platform segments supported by the fan blades 122. In alternative embodiments, one or more of the other forward fan stages may have arcuate platforms (see, for example, FIG. 5) as described above.

As shown in FIG. 2, the convertible fan system 140 comprises an outer fan system 130 having a circumferential row of outer fan blades 132 (FLADES™ blades) supported by the arcuate platform 124 and driven by the second fan stage 103. The outer fan system 130 is located in an outer flow path 117 that is formed between an outer casing 107 and an inner casing 115, the arcuate platform 124 and aft inner casing 125. The outer fan system 130 comprises a circumferential row of outer fan inlet guide vanes 135 located upstream and having a variable stagger angle geometry operated by known actuators 136. A circumferential row of outer fan outlet guide vanes (OGVs) 137 are located down stream from the outer fan blades 132. During operation, the outer fan blades 132 pressurize an outer flow stream 3 and form a pressurized outer exhaust stream 8 (alternatively referred to herein as a FLADES™ stream. The pressurized outer exhaust stream 8 may be used for a variety of purposes such as, for example, cooling the engine exhaust nozzle system, for thermal management, or for wing blowing. A heat exchanger system, such as, for example, shown as item 68 in FIG. 1, can be used for cooling and/or thermal management.

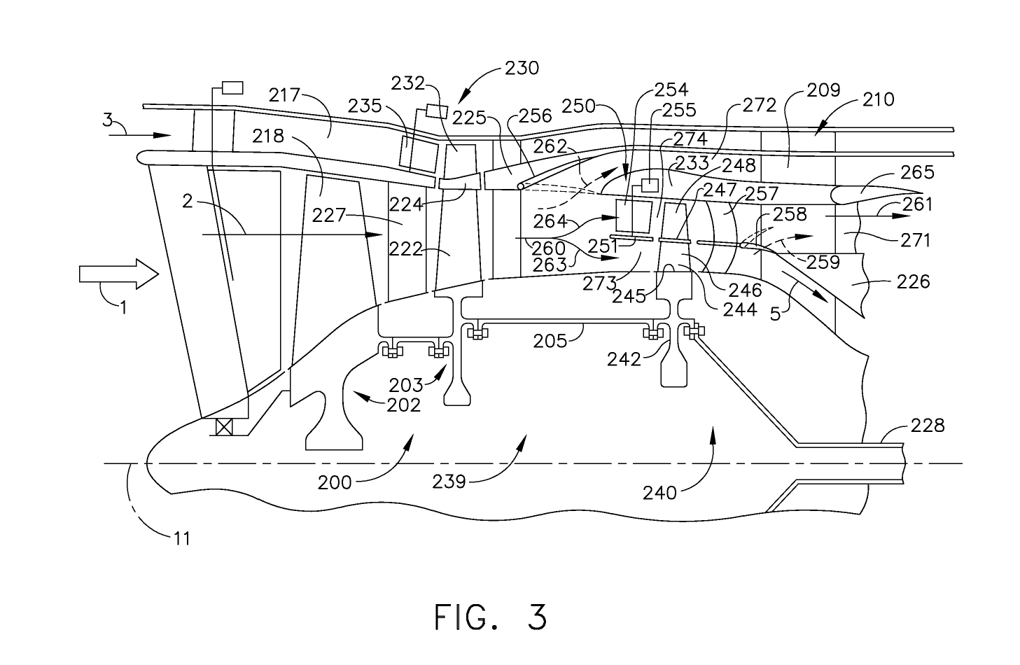

FIG. 3 shows a schematic cross-sectional view of a convertible fan system 240 according to another exemplary embodiment of the present invention. The convertible fan system 240 comprises a convertible fan rotor 242 having convertible fan blades 244 with arcuate shrouds 247 that form an inner portion 246 and an outer portion 248. The exemplary convertible fan system 240 further comprise a vane system 250 located axially forward from the convertible fan rotor 242. The exemplary vane system 250 shown in FIG. 3, has a plurality of outer vanes 254 that are arranged circumferentially around the longitudinal axis 11 and are located axially forward from the outer portions 248 of the fan blades 244. A static annular flow splitter 250 is provided (see FIG. 3) that splits the incoming CF flow stream 260 into a radially outer flow 264 and a radially inner flow 263. The static annular flow splitter 251 is located axially forward from the CF fan rotor 242. The static CF flow splitter 251 is located radially corresponding to the radial location of the arcuate splitters on the CF blades 244 such that the outer vanes 254 direct the CF fan outer flow 264 into the CF fan blade outer portion 248. The outer vanes 250 are variable vanes having variable stagger angles such that they can vary the volume and direction of the flow entering the CF fan blade 244 and the outer flow passage 274 such that fan tip pressure ratio of the fan system 240 can be varied. The variable outer vanes 254 are actuated by known methods using known outer vane actuators 255. Unlike the exemplary embodiment shown in FIG. 2, the exemplary embodiment shown in FIG. 3 does not have a variable vane system to direct the flow 263 to the inner portion of the fan blades 246. Control and optimization of the core flow 5 is accomplished by operating a bypass door 258 to create and control a core bypass flow 259 (hub bleed flow). Operation of the bypass door 258 facilitates the improvement of the fan hub stall margin during starting and low-power operation. The other features, their construction and their functions shown in FIG. 3 are substantially as described previously herein with respect to the embodiment shown and described in FIG. 2, with corresponding item numbers.

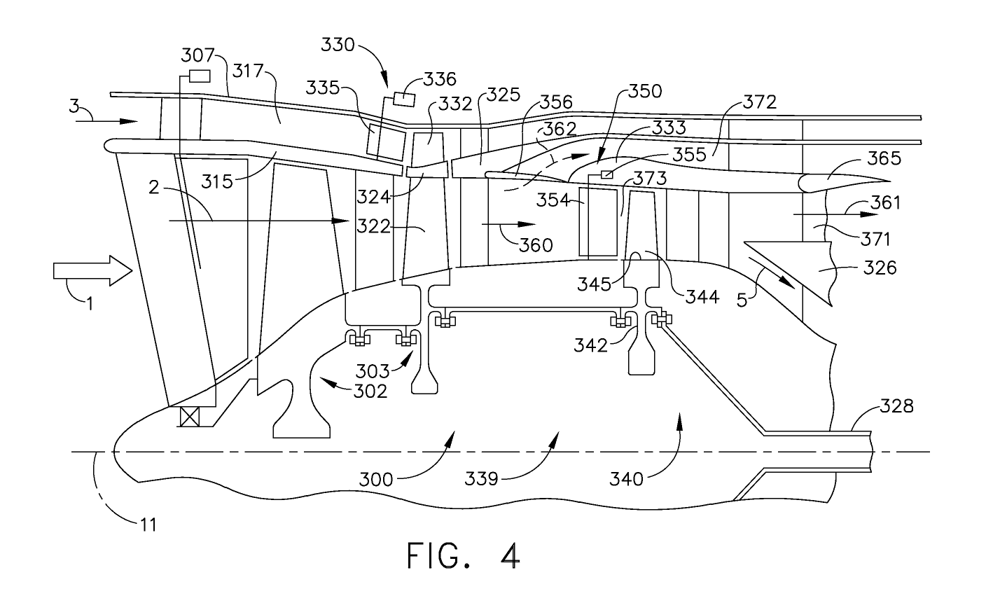

FIG. 4 shows a schematic cross-sectional view of a convertible fan system 340 according to another exemplary embodiment of the present invention. The convertible fan system 340 comprises an aft fan rotor 342 having a circumferential row of aft fan blades 344. The exemplary fan system 340 further comprises a vane system 350 located axially forward from the aft fan rotor 342. The exemplary vane system 350 shown in FIG. 4, has a plurality of vanes 354 that are arranged circumferentially around the longitudinal axis 11 and are located axially forward from the fan blades 344. In the exemplary embodiment shown in FIG. 4, the static annular flow splitter 251 and the arcuate shrouds 247 such as shown in FIG. 3 are eliminated. The incoming CF flow stream 360 is pressurized by the aft fan rotor blades 344 and is discharged towards a splitter 326 that is located axially aft from the aft fan rotor 342. The splitter 326 splits the pressurized flow discharged from the aft fan rotor 342 into a radially outer flow 361 and a radially inner core flow 5. The vane system 350 directs the aft fan in-flow 360 to the fan blades 344. The vanes 354 are variable vanes having variable stagger angles such that they can vary the volume and direction of the flow entering the aft fan blade 344 such that overall fan pressure ratio of the fan system 340 can be varied. The variable vanes 354 are actuated by known methods using known actuators 355. Unlike the exemplary embodiment shown in FIG. 3, the exemplary embodiment shown in FIG. 4 has a variable vane system 350 that directs the flow 360 to substantially the entire span of the fan blades 344. Control and optimization of the core flow 5 may be accomplished by operating an optional bypass door (not shown in FIG. 4). As shown in FIG. 4, the fan system 340 comprises an outer fan system 330 having a circumferential row of outer fan blades 332 (FLADES™ blades) supported and driven by the second fan stage 303. The outer fan system 330 is located in an outer flow path 317 that is formed between an outer casing 307 and an inner casing 315, the arcuate platform 324 and aft inner casing 325. The outer fan system 330 comprises a circumferential row of outer fan inlet guide vanes 335 located upstream and having a variable stagger angle geometry operated by known actuators 336. The use of the FLADE™ system 330, 332 shown in FIG. 4, although not directly controlling the aft fan tip and hub operating pressure levels independently, affords operational flexibilities for the fan system 340. The other features, their construction and their functions shown in FIG. 4 are substantially as described previously herein with respect to the embodiment shown and described in FIG. 3, with corresponding item numbers.

FIG. 5 is a schematic cross-sectional view of an adaptive, versatile gas turbine engine 576 according to an exemplary embodiment of the present invention incorporating a convertible fan system 540. FIG. 9 shows, in schematic cross-sectional view, another exemplary embodiment of an adaptive, versatile gas turbine engine 676 incorporating a convertible fan system 640 and an adaptive core 678 according to another exemplary embodiment of the present invention. As shown in FIGS. 5 and 9, the gas turbine engine 576, 676 comprises a multi stage fan system 501, 601 having an axially forward (“FWD”) fan system 500, 600 and an aft (“AFT”) fan system 540, 640, alternatively referred to herein as a convertible fan system, that is located axially aft from the FWD fan system. Although the FWD fan system 500 in the exemplary embodiment shown in FIG. 5 is shown comprising a single front stage fan rotor 506, the present invention is not thus limited. Multistage FWD fan systems can be also used. For example, the FWD fan system 600 shown in the exemplary embodiment in FIG. 9 is a multi stage FWD fan system having a first stage fan rotor 606 and a second stage fan rotor 620. In the exemplary embodiments shown in FIGS. 5 and 9, the gas turbine engine comprises an AFT fan system 540, 640 (convertible fan) having an aft fan rotor 542, 642 (alternatively referred to herein as a convertible fan rotor or CF fan rotor) that is located axially aft from the front stage fan rotor 506, 606. A core 578, 678 comprising a compressor 579, 679 is coupled to, and driven by, a high-pressure turbine 581, 681 (HPT). The aft fan rotor 542, 642 is driven by a low-pressure turbine 583, 683 (LPT) using an LPT shaft 528, 628. The FWD fan system is also driven by the LPT, as shown in FIGS. 5 and 9. Alternatively, the FWD fan system 500, 600 may be driven by another separate LPT (not shown).

The exemplary convertible fan systems 540, 640 are substantially similar in construction and function to the exemplary convertible fan system shown in FIG. 2 and described in detail previously herein. The convertible fan features, their construction and their functions are substantially as described previously herein with respect to the embodiment shown and described in FIG. 2, with corresponding item numbers. The aft fan rotor 542, 642 has a row of aft fan blades 544, 644 (alternatively referred to herein as convertible fan blades or CF fan blades) arranged circumferentially around the engine axis 11. An arcuate splitter 547, 647 (alternatively referred to herein as an arcuate shroud) is located on the fan blades 544, 644. In the assembled state of the aft fan rotor, the arcuate shrouds 547, 647 form a portion of an inner flow passage 573, 673 and an outer flow passage 574, 674. During the operation of the engine, an inner portion 546, 646 of the aft fan blade 544, 644 pressurizes an inner flow 563, 663 in the inner flow passage 573, 673 to have a hub pressure ratio. An outer portion 548, 648 of the aft fan blade 544, 644 pressurizes an outer flow 564, 664 in the outer flow passage 574, 674 to have a tip pressure ratio. In one aspect of the present invention, the fan tip pressure ratio and fan hub pressure ratio in the aft fan system 540, 640 can be changed, even while the air flow 2 (see FIGS. 5 and 9) into the front stage fan rotor 506, 606 is held substantially constant. In another aspect of the present invention, the gas turbine engine 576, 676 comprises an annular inner bypass passage 571, 671 around the engine axis 11 that is adapted to flow an inner bypass flow 561, 661 from the fan system 501, 601. The gas turbine engine 576, 676 further comprises an annular outer bypass passage 572, 672 around the engine axis 11 that is adapted to flow an outer bypass flow 562, 662 from the fan system 501, 601. The outer flow 564, 664 pressurized by aft fan rotor 542, 642 flows into the inner bypass passage 571, 671. At least a portion of the inner flow 563, 663 pressurized by the inner portion 546, 646 of the fan blade 544, 644 forms a core flow 5 into the compressor 579, 679. A core bypass door 558, 658 may be provided (see FIGS. 5, 9) adapted to control a core bypass flow 559, 659. A blocker door 556, 656 may also be used as shown in FIGS. 5 and 9 that is adapted to prevent a reverse flow in the outer bypass passage 572, 672 as described previously herein.

In one aspect of the present invention, engine 576, 676 has a static annular splitter 551, 651 located axially forward from the aft fan rotor 542, 642 wherein a flow stream 560, 660 into the aft fan rotor 542, 642 is bifurcated to form the inner flow 563, 663 in the inner flow passage 573, 673 and the outer flow 564, 664 in the outer flow passage 574, 674. In another aspect of the present invention, the gas turbine engine 576, 676 as shown in FIGS. 5 and 9 has a vane system 550, 650 located axially forward from the aft fan rotor 542, 642. The vane system 550, 650 is constructed using known methods such that it can vary the flow in inner flow passage 573, 673 and in the outer flow passage 574, 674 such that overall pressure ratio of the fan system 501, 601 can be varied as needed during engine operation. The vane system 550, 650 has an outer vane 554, 654 located radially outward from the splitter 551, 651. In order to vary the flow rates and directions into the aft fan rotor, a portion of the outer vane 554, 654 may be movable by an actuator 555, 655 to vary the vane stagger angles. Known variable vane actuators may be used for this purpose. In one embodiment (shown in FIGS. 5 and 9) the vane system 501, 601 further comprises an inner vane 552, 652 located radially inboard from the splitter 551, 651, and may be movable by known actuators 553, 653. The method of operating the engine 576, 676 using these features is described subsequently herein.

In one aspect of the present invention, the gas turbine engine 576, 676 has a forward mixer 565, 665 (alternatively referred to herein as a Variable Area Bypass Injector or “VABI”) located downstream from the aft fan rotor 542, 642. The fwd VABI is adapted using known methods of construction to enhance the mixing of the inner bypass flow 561, 661 and the outer bypass flow 562, 662 to form a mixed bypass flow 566, 666. The inner bypass flow and outer bypass flow may have different pressure levels and flow rates. Their mixing is done by the fwd VABI in order to minimize mixing pressure losses down-stream from the fan system. The gas turbine engine 576, 676 may also have a rear mixer 584, 684 (rear VABI) located down-stream from the low-pressure turbine 583, 683 to enhance the mixing of the core stream 567, 667 (hot exhaust stream) from the low-pressure turbine 583, 683 and the mixed bypass flow 566, 666 that is relatively cooler. Known VABI systems can be used. In alternative embodiments of the present invention, the fwd VABI mixer 565, 665 and/or the rear VABI mixer 584, 684 may be of a variable type or fixed type. When variable, they are scheduled to satisfy certain operating limits of the engine 576, 676 and to minimize mixing losses (i.e. maximize performance). When they are fixed, they serve to enhance the flow mixing process for improved performance. In some applications, the gas turbine engines 576, 676 may also have a circumferential row of variable inlet guide vanes 511, 611 (IGVs) located axially forward from the front fan stage fan rotor 506, 606. The IGVs, operated using known actuators, can be used to control the flow of air 2 to the front stage fan rotor 506, 606.

In another aspect of the present invention, the gas turbine engine 576, 676 has a front stage fan rotor 506, 620 having a circumferential row of fan blades 518, 622 arranged circumferentially around the engine axis 11 that support and drive a an outer fan 530, 630 (alternatively referred to herein as a FLADE™ fan). FIG. 5 shows an outer fan system 530 having a circumferential row of outer fan blades 532 (FLADE™ blades) that are located radially outward from the front stage fan rotor 506. In the embodiment shown in FIG. 9, the outer fan system 630 has a circumferential row of outer fan blades 632 supported and driven by the second stage fan rotor 620. The FLADE™ blades 532, 632 are adapted to rotate with the fan blades 518, 622 to pressurize an outer flow stream 3 in an outer flow path 517, 617. The outer fan system 530, 630 may further comprise a plurality of outer fan inlet guide vanes 532, 635 that are adapted to control the outer flow stream 3 in the outer flow path 517, 617. In one embodiment (see FIGS. 5 and 9) the gas turbine engine 576, 676 comprises an air bleed conduit 585, 685 and air bleed door 586, 686 that is adapted to remove at least a portion of the flow 8 in the outer flow path 517 as needed for uses such as wing blowing. In an exemplary embodiment, the flow stream 8 is used for cooling portions of the engine 576 such as, for example, an exhaust nozzle (see FIG. 1).

The various figures and descriptions provided herein show convertible fan systems and adaptive engines that provide operational flexibilities that conventional fan systems and engines cannot provide. As disclosed herein, the convertible fan systems, and engines having such fan systems, can provide further advantages using the disclosed outer fan systems such as the FLADE™ systems in a front fan rotor coupled to the unique rear fan rotor having an annular splitter through the rotor as shown herein. Unlike conventional fan systems, use of a convertible fan system as disclosed herein permits different tip and hub design fan pressure ratio levels. Further, use of additional systems and features shown herein, such as the tip inlet guide vanes (IGV) 154, 254, 554, 654 having variable geometry, bypass doors 158, 258, 558, 658 short outer bypass passages (ducts) 172, 272, 572, 672, front variable area by-pass injector (“VABI”) 165, 265, 365, 565, 665 systems, rear VABI 584, 684 systems permit the tip pressure ratio and flow in the convertible fan rotor 142, 242, 342, 542, 642 to be significantly reduced during part-power (i.e., reduced from maximum power/thrust) engine operations. Unlike conventional gas turbine engines, main fan flow 2 in the front stages of the forward fan system 100, 200, 300, 500, 600 can be maintained at constant or near-constant design flow levels even when the engine thrust is reduced into the 50-60% levels for part-power operations. This is made possible by the use of the convertible engine features described herein, since the effective fan pressure ratio level in the by-pass duct 171, 271, 371, 571, 671 (and at the static pressure balance plane near the front VABI 165, 265, 365, 565, 665) can be reduced, thereby allowing the core 578, 678 of the convertible engine 576, 676 to be throttled back to reduce the core stream 567, 667 exit pressure and temperature. As described herein, the FLADE™ stream 3 pressure and flow can be adjusted using the FLADE™ variable IGV system 135, 136, 235, 236, 335, 336, 535, 536 to further optimize the total operating airflow and overall thrust effective fan system pressure levels for minimizing both uninstalled and installed specific fuel consumption (SFC) levels.

FIGS. 6, 7 and 8 illustrate how the variable tip and hub IGV's of the preferred embodiment shown in FIG. 2, and implemented in the exemplary engines shown FIGS. 5 and 9, are used to adjust both the overall fan pressure ratio and pressure ratios of both the fan tip and fan hub. The front block fan stages 102, 103 could be held at constant flow even though the engine power and/or thrust is lowered to 40-50% of maximum level. Although a two-stage front block fan is shown in FIG. 3, some fan system designs might only have one single stage front fan 506, such as, for example, shown in FIG. 5. The tip IGV 154, 254, 554, 654 (alternatively referred to herein as the outer vane) of the CF Fan system 140, 240, 540, 640 is closed to reduce the overall tip pressure ratio when the engine thrust is reduced at constant fan flow. The FLADE™ outer fan section flow 3 and operating pressure ratio are independent of the main fan system 140, 240, 540, 640 and can be adjusted as needed by proper scheduling of its IGV 135, 235, 335, 535, 635.

The independently variable hub IGV of the last stage can be used to optimize the core stream flow 5 at all engine power/thrust settings, and in some applications, may even eliminate the need for a hub bleed system. It can also be sized/scheduled to help control the front block operating line during transition from single bypass mode (i.e., max fan tip pressure) to double bypass mode (i.e., min fan tip pressure), with the main front fan flow being held constant. Smooth transition from a single bypass to double bypass is made possible by proper scheduling of the variable IGVs, the bypass door, blocker door, the front VABI, and the aft VABI. It may be possible to have this scheduling system to be self-actuating using a pressure regulated bypass door system.

An exemplary gas turbine engine 576 having an exemplary embodiment of a convertible fan system is shown in FIG. 5. A method of operating a gas turbine engine according to an exemplary of the present invention is described as follows, in reference to FIGS. 6, 7 and 8. In the method, a first operating power level is selected. This power is level may correspond, for example, to a maximum power level. This power level may also correspond to the maximum thrust level of the engine. The expressions “maximum power level” and “maximum thrust level” are used herein interchangeably and have the same meaning for the purposes of explanation of the invention. FIG. 6 is an example of the fan operating characteristics of the front block fan system, such as item 502 in FIG. 5. A flow of air 2 is directed to a front fan stage 502 located near the front of the engine 576. Referring to FIG. 6, the mass flow rate corresponding to the selected maximum power level is shown as “W1” 701. The fan speed corresponding to the selected maximum power level is shown as “S1” 703 and front fan stage 502 pressure ratio corresponding to the selected maximum power level is shown as “P1” 705. In an exemplary embodiment of the present invention, “W1” is the 100% corrected flow of the front stage fan 502, “S1” is the 100% corrected speed of the front fan stage 502 and the front stage fan 502 pressure ratio “P1” is about 2.9.

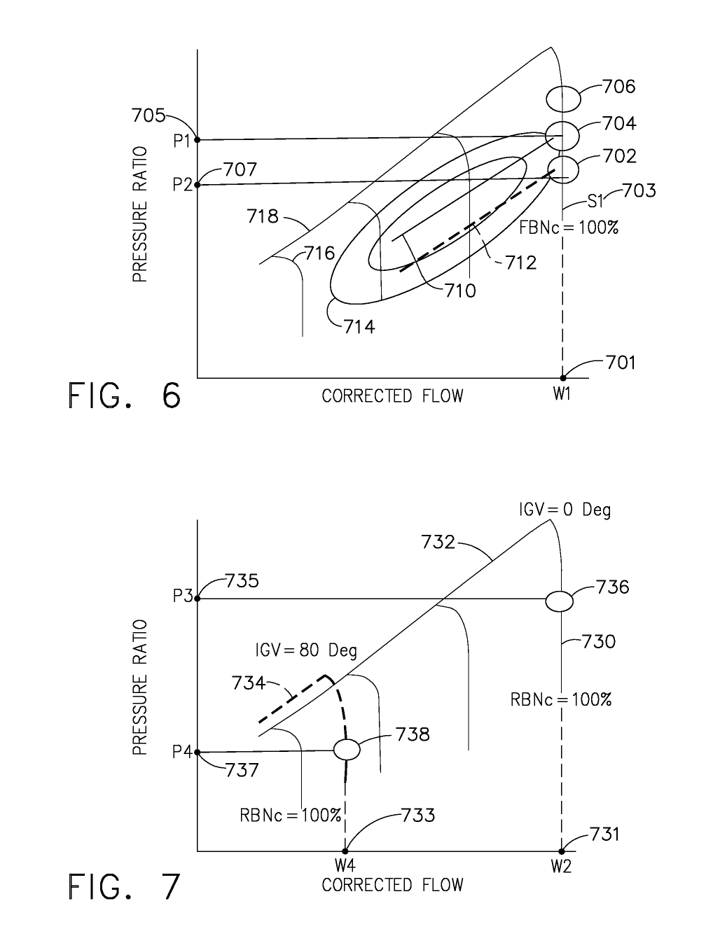

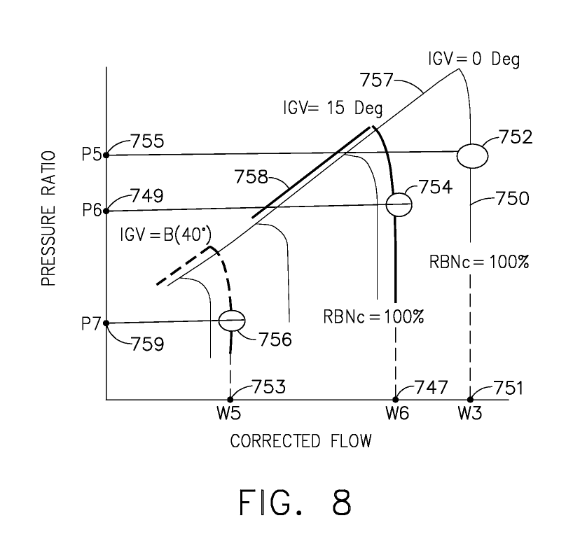

A portion 564 of the flow 560 from the front fan stage 502 (see FIG. 5) is directed to an aft fan rotor 542 that is located axially aft from the front fan stage 502. FIG. 7 is an example of the fan operating characteristics of outer portion of the aft fan rotor 542 of the convertible fan system. The portion 564 of the air flow is pressurized by the aft fan rotor 542 is to a first tip pressure ratio “P3” 735 when the corrected flow rate is “W2” 731 (see FIG. 7). In an exemplary embodiment, “W2” is the 100% corrected flow of the aft fan outer portion 548 and the outer portion 548 pressure ratio “P3” is about 1.48 and the corresponding aft fan rotor 542 corrected speed is about 100%. The result of the combined pressurization by the forward fan system and the aft fan is to generate a first overall fan pressure ratio “A” in the engine. For the exemplary embodiment described above, “A” is about 4.3 (=2.9*1.48). The portion 563 of the air flow is pressurized by aft fan hub 546 to a first hub pressure ratio “P5” 755 when the corrected flow rate is “W3” 751 (see FIG. 8). In an exemplary embodiment “W3” is the 100% corrected flow for the aft fan hub portion 546 and the inner portion 546 pressure ratio “P5” is about 1.48 and corresponding aft fan rotor 542 corrected speed is about 100%. The result of the combined pressurization by the forward fan system and the aft fan is to generate a first overall fan hub pressure ratio “AA” in the engine. For the exemplary embodiment described above, “AA” is about 4.3 (2.9 *1.48).

A portion 563 of the air flow from the front fan stage 502 (see FIG. 5) is pressurized and discharged to an inner bypass passage 571 (see FIG. 5). Another portion of this pressurized flow is directed to a compressor 579 to form a core flow 5. When the bleed door 558 is opened, a portion 559 of the flow 563 enters the inner bypass duct 571, reducing the amount of the core flow 5. The core flow 5 flows towards a compressor 579 in a core inlet passage and is compressed using the compressor 579 prior to combustion in a combustor 580.

The method of operating the engine further comprises the step of selecting a second operating power level that is lower than the first operating power level. The corresponding fan maps at this lower power/thrust setting is shown as broken lines in FIGS. 6-8. At this lower power/thrust setting, the flow rate in the front fan stage 502 is held substantially constant at about “W1” and corrected speed (see FIG. 6) and the front fan stage pressure is lowered to “P2”. In the example used herein, P2 has a value of about 2.5. Further, the flow in the aft fan rotor 542 outer portion 548 is reduced, such as, for example, by closing a variable inlet guide vane 554. The reduced flow rate in the outer portion 548 is denoted by “W4” 733 corresponding to the lower power/thrust level (See FIG. 7). The flow in the outer portion 548 of the aft fan rotor 542 is pressurized to a second tip pressure ratio “P4” 737 (See FIG. 7). This generates a second overall pressure ratio “B” (at the lower power/thrust level) that is substantially lower than the first overall fan pressure ratio “A” (at the higher power/thrust setting), even while holding the flow rate “W1” in the front fan stage 502 substantially constant. In the exemplary embodiment described above, the pressure ratio “P4” is about 1.05 and the overall pressure ratio “B” is about 2.63 (=2.5*1.05). The lower power/thrust setting of the engine is usually chosen as the portion of the engine operating cycle which is used most, such as the cruise portion, and the pressure ratios and transition operating process are chosen so as to minimize the specific fuel consumption at the lower power setting.

In the exemplary embodiments shown herein, the step of reducing the flow in the aft fan rotor 542 is performed by partially closing a variable inlet guide vane 554 that is actuated by a known actuator 555. When the flow in the outer portion of the aft fan rotor is reduced, a blocker door 556 is opened at least partially such that a portion 562 of the flow from the front fan stage 502 is flown into an outer bypass passage 572. The opening of the blocker door 556 is determined, at least partially, by the available stability margin of the front fan 502. A mixer 565 that located down stream from the aft fan 542 is engaged such that the inner bypass flow 561 and the outer bypass flow 562 achieve a substantial pressure balance when they mix downstream from the aft fan rotor 542. In some operating conditions, the method described herein further comprises the step of opening a bypass door 558 and establishing a core bypass flow 559 to control the core flow 5 to better match the core compressor characteristics.

In an exemplary embodiment of the present invention, the method further comprises the step of pressurizing a portion 563 of the flow from the front fan stage 502 in an inner portion 546 of the aft fan rotor 542 to a first hub pressure ratio P6 at the first operating power level (maximum power/thrust setting in the example). See FIG. 8. The core flow 5 can be controlled by operating a variable inlet guide vane (IGV) 552 upstream from the inner portion 546 of the aft fan rotor 542. In the example described herein, “P6” has a value of about 1.38, and the IGV is closed by about 15 degrees. For lower power settings, the IGV 552 may be closed to a suitable degree (for example 40 to 50 degree) as necessary to match the compressor 579 requirements. In some applications, such as the exemplary embodiment shown in FIG. 5, the flow of air 2 to the front fan stage 502 is controlled by operating a variable inlet guide vane 511 located axially forward from the front fan stage 502 using a known actuator 513.

In some applications, such as the exemplary embodiment shown in FIG. 5, an outer flow stream 3 through in an outer flow passage 517 is compressed using an outer fan 532 located on a front fan stage rotor 506. These outer fans are alternatively known as FLADES™, as described previously herein. Controlling of the outer flow stream 3 is performed by operating a variable inlet guide vane 535 located upstream from the outer fan 532 using known actuators 536.

In another exemplary method of operating the gas turbine engine shown in FIG. 5, to aid in the transition from a high power/thrust setting to a lower power/thrust setting, where the front fan stage 502 pressure ratio is lowered to a level “P2” from a higher level “P1” (see FIG. 6) the pressure ratio of the front fan stage is allowed to rise to a higher level than “P1” (see operating point marked by item number 706). This occurs just before the blocker door 556 is opened (thereby flowing a portion of the flow 562 from the front fan stage 502 into an outer bypass passage 572). To maintain front fan stage and aft fan stage flow continuity, the convertible fan outer inlet guide vanes 554 begin to close to start the process of reducing the overall fan tip pressure ratio while maintaining a substantially constant fan flow in the front fan stage 552. During this transition, the convertible fan inner guide vanes 552 may be opened (see item 736 in FIG. 7) to allow more core flow 5 to optimize the operation of the engine system 576. The core flow 5 may further be fine-tuned by opening a bypass door 558 thereby establishing a core bypass flow 559. In the exemplary embodiment of the engine system 576 shown in FIG. 5, a variable throat area (not shown in FIG. 5, but substantially similar to item 69 shown in FIG. 1) is provided in the engine exhaust system wherein the main exhaust nozzle throat area can be varied as necessary, such as for example, by opening the throat area when the engine thrust is reduced.

FIG. 9 shows a schematic cross-sectional view of an exemplary versatile gas turbine engine 676 having an adaptive core 678 according to an exemplary embodiment of the present invention. The exemplary versatile gas turbine engine 676 comprises a convertible fan system 640 adapted to have a variable fan pressure ratio while an air flow into the convertible fan system 640 remains substantially constant. The exemplary versatile gas turbine engine 676 shown in FIG. 9 further comprises an adaptive core 678 having a compressor 679 capable of maintaining a substantially constant core pressure ratio while a core airflow flow 5 rate is varied to enable efficient engine operation under a variety of flight conditions. The convertible fan system, such as item 640 in FIG. 9, and its operation have been described previously herein. It comprises an annular inner bypass passage 671 around an engine axis 11 that is adapted to flow an inner bypass flow 661 from the convertible fan system 640 and an annular outer bypass passage 672 around the engine axis 11 that is adapted to flow an outer bypass flow 662 from the convertible fan system 640. The exemplary convertible fan system 640 has a front stage fan rotor 622 and an aft fan rotor 642 that is located axially aft from the front stage fan rotor 622 and has a row of aft fan blades 644 arranged circumferentially around an engine axis 11. The aft fan rotor 642 has an arcuate splitter 647 on the fan blades 644 that form a portion of an inner flow passage 673 and an outer flow passage 674. An inner portion 646 of the aft fan blade 644 pressurizes an inner flow 663 in the inner flow passage 673 to have a hub pressure ratio. An outer portion 648 of the aft fan blade 644 pressurizes an outer flow 664 in the outer flow passage 673 to have a tip pressure ratio. The convertible fan system 640 has a vane system 650 located axially forward from the aft fan rotor 642. The vane system 650 has variable vanes that are adapted to be able to vary the flow in the aft fan blades 644 such that overall pressure ratio of the fan system 640 can be varied as needed to attain flexible and efficient engine operation for a variety of flight power/thrust conditions. Use of the convertible fan system 640 enables the engine 676 to have a variable fan pressure ratio while an air flow 2 into the convertible fan system 640 remains substantially constant. The outer flow 664 pressurized by aft fan rotor 642 flows into an annular inner bypass passage 671. A portion of the inner flow 663 pressurized by the inner portion 646 of the fan blade 644 forms a core flow 5 that flows into the compressor 679. The exemplary engine 676 has a core bypass door 658 (see FIG. 9) that is adapted to control a core bypass flow 659. A blocker door 656 may be used in the outer bypass passage 672 to control the outer bypass flow 662 and to prevent a reverse flow in the outer bypass passage 672 when the down-stream pressure is high.

FIG. 9 shows an exemplary adaptive core 678 in the versatile adaptive engine 676 according to an exemplary embodiment of the present invention. The exemplary adaptive core 678 has a front-block compressor 691 and a rear-block compressor 692 coupled to a turbine 681 that drives the compressors. In FIG. 9, the front-block compressor 691 is shown as a multi-stage axial-flow compressor and the rear-block compressor 692 is shown as a centrifugal compressor. Alternatively, the rear-block compressor 692 may also be an axial flow compressor. The use of a two-block compressor system in the adaptive core 678 as shown in FIG. 9 gives the compressor system the versatile ability to both adjust core pressure at constant flow to control maximum compressor discharge temperature and pressure levels, and also to maintain a substantially constant core compressor pressure ratio while the core airflow 5 flow rate into the compressor is lowered, such as for example, at low power or low thrust operation of the engine 676. This is shown in the compressor operating map shown in FIG. 10 and explained subsequently herein. The flow control into the front-block of the two-block compressor shown in FIG. 9 is accomplished by operating a front-block inlet guide vane 689 capable of varying the flow into the front-block compressor 691. The flow control into the rear-block of the two-block compressor is accomplished by operating a rear-block inlet guide vane 694 capable of varying the flow into the rear-block compressor 692. The adaptive core 678 has a rear-block bypass passage 693 that can receive a flow from an annular inter-block passage 696 when the rear-block IGV 694 is partially or fully closed. The annular inter-block passage 696 is located between the front-block compressor 691 and the rear-block compressor 692. A variable area combustor diffuser system 699 may be used to help in transitioning between “rear-block on” and “rear-block off” modes of engine operation. The exemplary gas turbine engine 672 may optionally have a variable high-pressure turbine nozzle system 697, and/or a variable low-pressure turbine nozzle system 698 as schematically shown in FIG. 9. The variable turbine nozzles 697, 698 may be operated by known means to attain turbine flow-function matching during operation of the engine 676. The exemplary gas turbine engine according 676 further comprises a forward mixer 665 (alternatively known as a “fwd VABI”) that is adapted to enhance mixing of an inner bypass flow 661 and an outer bypass flow 662 to form a mixed bypass flow 666 (see FIG. 9). A rear mixer 684 (alternatively known as a “rear VABI”) located down-stream from a low pressure turbine 683 may be used to enhance mixing of a mixed bypass flow 666 and the hot exhaust from the low pressure turbine 683. Variable Area Bypass Injectors (“VABI”) are known in the art. In the exemplary embodiment of the engine system 676 shown in FIG. 9, a variable throat area (not shown in FIG. 9, but substantially similar to item 69 shown in FIG. 1) is provided in the engine exhaust system wherein the main exhaust nozzle throat area can be varied as necessary, such as for example, by opening the throat area when the engine thrust is reduced.

The exemplary versatile gas turbine engine 676 optionally comprises, as shown in FIG. 9, an outer fan system 630. The outer fan system 630 comprises a circumferential row of outer fan blades 632 (alternatively referred to herein as FLADES™ blades) that are located radially outward from a front stage fan rotor 620. The outer fan blades 632 are carried by a front stage fan rotor, such as, for example, the second stage fan rotor 620 in FIG. 9. The outer fan blades 632 rotate with the front stage fan rotor 620 to pressurize an outer flow stream 3 in an outer flow path 617. The pressurized outer flow stream 8 may be used for a variety of purposes. For example, the exemplary gas turbine engine shown in FIG. 9 has an air bleed conduit 685 that is adapted to remove at least a portion of the flow 8 in the outer flow path 517 for use outside the engine, such as, for example, wing blowing. A portion of the flow 8 in the outer flow path 617 may be used to cool a portion of the engine 676, such as the exhaust nozzle, as shown schematically, for example, in FIG. 1.

FIG. 10 shows how to use the exemplary engine shown in FIG. 9 for different flight conditions on an operating map of the two-block adaptive compressor 690 such as, for example, shown in FIG. 9. Two operating maps are shown in FIG. 10, one with the “Rear Block Off” and one with the “Rear Block On”. The rear-block compressor 692 is “OFF” when the flow into the rear-block compressor 692 is substantially cut off (except for a small purge flow) by closing the rear-block variable inlet guide vane (IGV) 694 using known actuators 695. Item numbers 800 represent the speed lines (% speed, such as 100%, 98% 96% shown in FIG. 10). The operating line with the “Rear Block Off” (such as, for example, during Take-Off operation of the engine 676) is shown as item 814 and the corresponding stall line is shown as item 811. Item numbers 813, 803 etc. represent contours of constant efficiency. The pressure ratio of the adaptive core 678 with the “Rear Block Off” is shown as item 812 at a 100% speed, and may, for example, represent the design pressure ratio for the front-block compressor. During another mode of operation of the versatile adaptive engine 676, such as for example, cruise-operation, the flow may be reduced, for example, from operating point item 812 to operating point item 808. The operating line with the “Rear Block On” (such as, for example, during Cruise operation of the engine 676) is shown as item 802 and the corresponding stall line is shown as item 810. The “Rear Block On” is accomplished by opening the rear block IGV 694 to allow some of the flow from the front-block compressor 691 into the rear-block compressor 692 flow. By turning the “Rear Block On”, the pressure ratio (see item 808) of the adaptive core 678 may be maintained at substantially same level as before (see item 812), even when the corrected flow is reduced (see items 812 and 808) for low power/thrust conditions. Alternatively, for other engine operating regimes, the engine may be operated to achieve a higher pressure ratio, such as from item 812 to item 804, with the core flow and corrected speed (item 800) substantially constant.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A gas turbine engine comprising:
a convertible fan system adapted to have a variable fan pressure ratio while an air flow into the convertible fan system remains substantially constant; and
an adaptive core having a compressor capable of maintaining a substantially constant core pressure ratio while a core airflow flow rate is varied.

2. A gas turbine engine according to claim 1 further comprising:
an annular inner bypass passage around an engine axis that is adapted to flow an inner bypass flow from the convertible fan system; and
an annular outer bypass passage around the engine axis that is adapted to flow an outer bypass flow from the convertible fan system.

3. A gas turbine engine according to claim 1 comprising a front stage fan rotor and an aft fan rotor that is located axially aft from the front stage fan rotor wherein the aft fan rotor has a row of aft fan blades arranged circumferentially around an engine axis and an arcuate splitter that forms a portion of an inner flow passage and an outer flow passage.

4. A gas turbine engine according to claim 3 wherein an inner portion of the aft fan blade pressurizes an inner flow in the inner flow passage to have a hub pressure ratio and an outer portion of the aft fan blade pressurizes an outer flow in the outer flow passage to have a tip pressure ratio.

5. A gas turbine engine according to claim 3 wherein the convertible fan system further comprises a vane system located axially forward from the aft fan rotor that is adapted to be able to vary the flow in the aft fan blades such that pressure ratio of the fan system can be varied.

6. A gas turbine engine according to claim 4 wherein the outer flow pressurized by aft fan rotor flows into an annular inner bypass passage.

7. A gas turbine engine according to claim 4 wherein at least a portion of the inner flow pressurized by the inner portion of the fan blade forms a core flow into the compressor.

8. A gas turbine engine according to claim 7 further comprising a bypass door that is adapted to control a core bypass flow.

9. A gas turbine engine according to claim 2 further comprising a blocker door that is adapted to prevent a reverse flow in the outer bypass passage.

10. A gas turbine engine according to claim 3 further comprising a forward mixer located downstream from the aft fan rotor that is adapted to enhance mixing of an inner bypass flow and an outer bypass flow to form a mixed bypass flow.

11. A gas turbine engine according to claim 3 further comprising an outer fan system having a circumferential row of outer fan blades that are located radially outward from the front stage fan rotor and adapted to rotate with the fan blades to pressurize an outer flow stream in an outer flow path.

12. A gas turbine engine comprising:
an adaptive core having a front-block compressor and a rear-block compressor coupled to a turbine, the adaptive core being capable of maintaining a substantially constant core pressure ratio while a core airflow flow rate is varied; and
a convertible fan system adapted to have a variable fan pressure ratio while an air flow into the convertible fan system remains substantially constant.

13. A gas turbine engine according to claim 12 wherein the front-block compressor is a multi-stage axial compressor.

14. A gas turbine engine according to claim 12 wherein rear-block compressor is a centrifugal compressor.

15. A gas turbine engine according to claim 12 further comprising a front-block inlet guide vane capable of varying the flow into the front-block compressor.

16. A gas turbine engine according to claim 12 further comprising a rear-block inlet guide vane capable of varying the flow into the rear-block compressor.

17. A gas turbine engine according to claim 12 further comprising a rear-block bypass passage adapted to receive a flow from an annular inter-block passage located between the front-block compressor and the rear-block compressor.

18. A gas turbine engine according to claim 12 further comprising a variable high-pressure turbine nozzle system.

19. A gas turbine engine according to claim 12 further comprising a variable low-pressure turbine nozzle system.

20. A gas turbine engine according to claim 12 further comprising a forward mixer that is adapted to enhance mixing of an inner bypass flow and an outer bypass flow to form a mixed bypass flow.

21. A gas turbine engine according to claim 12 further comprising a rear mixer located down-stream from a low pressure turbine that is adapted to enhance mixing of a mixed bypass flow and the hot exhaust from the low pressure turbine.

22. A gas turbine engine according to claim 12 further comprising an outer fan system having a circumferential row of outer fan blades that are located radially outward from a front stage fan rotor and adapted to rotate with the front stage fan rotor to pressurize an outer flow stream in an outer flow path.

23. A gas turbine engine according to claim 22 further comprising an air bleed conduit that is adapted to remove at least a portion of the flow in the outer flow path.

24. A gas turbine engine according to claim 22 wherein at least a portion of the flow in the outer flow path is adapted to cool a portion of the engine.
